(19) United States
(12) Patent Application Publication
(10) Pub. No.: US 2024/0420723 A1
(43) Pub. Date: Dec. 19, 2024

(54) TWO-STAGE FRAMEWORK FOR ZERO-SHOT IDENTITY-AGNOSTIC TALKING-HEAD GENERATION

(71) Applicant: Salesforce, Inc., San Francisco, CA (US)

(72) Inventors: Zhichao Wang, Cambridge, MA (US); Keld Lundgaard, Cambridge, MA (US); Mengyu Dai, Cambridge, MA (US)

(21) Appl. No.: 18/527,668

(22) Filed: Dec. 4, 2023

Related U.S. Application Data
(60) Provisional application No. 63/508,852, filed on Jun. 16, 2023.

(51) Int. Cl. G10L 21/10; G10L 13/08

(52) U.S. Cl. CPC G10L 21/10; G10L 13/08; G10L 2021/105

(57) ABSTRACT

Methods, systems, apparatuses, devices, and computer program products are described. A system may input a first audio stream (e.g., audio recording) and a corresponding text sting into a machine learning model. The first audio stream and the text string may correspond to a first identity (e.g., person). Based on an output of the machine learning model, the system may generate a second audio stream associated with a second identity and mimics the first audio steam. For example, the second audio stream may be a generated recording of the second identity speaking the first text string. In addition, the system may generate a video depicting the second identity speaking the first text string (e.g., the second audio stream) based on combining the second audio stream with some image or previous video of the second identity. For example, the system may generate the video based on generating a head motion sequence.

### CROSS REFERENCE

The present Application for Patent claims the benefit of U.S. Provisional Patent Application No. 63/508,852 by WANG et al., entitled “A TWO-STAGE FRAMEWORK FOR ZERO-SHOT IDENTITY-AGNOSTIC TALKING-HEAD GENERATION,” filed Jun. 16, 2023, assigned to the assignee hereof, and expressly incorporated by reference herein.

### FIELD OF TECHNOLOGY

The present disclosure relates generally to database systems, data processing, and data generation, and more specifically to a two-stage framework for zero-shot identity-agnostic talking-head generation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may support systems that include artificial intelligence chatbots (e.g., ChatGPT) for information gathering and analysis. However, the information provided to such chatbots to generate an output may be limited to text, and the visualization of this information may likewise be constrained. For example, the chatbot may lack the functionality to use (as inputs) or output images, videos, and the like. Some zero-shot, text-to-video (TTV) approaches may be used to transform text into videos using artificial intelligence (AI) or other machine learning model techniques. However, such techniques may rely heavily on an identifier associated with the inputs to the AI or machine learning model, which may limit their effectiveness scalability. For example, the AI or machine learning model may output a video of a specific person based on the text that is input into the model being associated with that same person. That is, a current TTV model may be unable to output a video unless the TTV model is trained on specific inputs.

### BRIEF DESCRIPTION OF THE DRAWINGS

FIG. 1 illustrates an example of a data processing system that supports a two-stage framework for zero-shot identity-agnostic talking-head generation in accordance with aspects of the present disclosure.

FIG. 2 shows an example of a TTV model that supports a two-stage framework for zero-shot identity-agnostic talking-head generation in accordance with aspects of the present disclosure.

FIG. 3 shows examples of TTS models that support a two-stage framework for zero-shot identity-agnostic talking-head generation in accordance with aspects of the present disclosure.

FIG. 4 shows examples of talking head generation models 400 and 401 that support a two-stage framework for zero-shot identity-agnostic talking-head generation in accordance with aspects of the present disclosure.

FIG. 5 shows an example of a spectrogram model that supports a two-stage framework for zero-shot identity-agnostic talking-head generation in accordance with aspects of the present disclosure.

FIG. 6 shows a block diagram of an apparatus that supports a two-stage framework for zero-shot identity-agnostic talking-head generation in accordance with aspects of the present disclosure.

FIG. 7 shows a block diagram of a TTV manager that supports a two-stage framework for zero-shot identity-agnostic talking-head generation in accordance with aspects of the present disclosure.

FIG. 8 shows a diagram of a system including a device that supports a two-stage framework for zero-shot identity-agnostic talking-head generation in accordance with aspects of the present disclosure.

FIGS. 9 through 12 show flowcharts illustrating methods that support a two-stage framework for zero-shot identity-agnostic talking-head generation in accordance with aspects of the present disclosure.

### DETAILED DESCRIPTION

Some systems may support artificial intelligence (AI) chatbots used for information gathering and analysis. Such chatbots may be trained on large sets of data. Based on receiving an input from a user (e.g., a question, a prompt, a request, etc.), the chatbot may generate a corresponding output that is effectively a likely prediction corresponding to the input. In some aspects, the chatbot may support text-to-video (TTV) techniques which may involve generating videos based on a given text, enabling enhanced visualization of the information output by the chatbot. For example, the chatbot may receive an input from the user indicating some text string and a person (also referred to herein as an identity) the user wishes to speak the text. If the chatbot is trained on a set of data including audio clips and video clips of the identity, the chatbot may output a video clip showing the identity speaking the input text string.

According to one or more aspects of the present disclosure, a device (e.g., a user device, server, server cluster, database, etc.) may use the described techniques to perform a two-stage procedure for zero-shot identity-diagnostic talking-head generation. Specifically, the described techniques provide for performing a text-to-speech (TTS) procedure followed by an audio-driven talking-head generation procedure. During the TTS procedure of the two-stage framework described herein, a first audio stream (e.g., recorded speech) and a first text string (e.g., written text) corresponding to the first audio stream may be input into a machine learning model. The first audio stream and the first text string may correspond to a first identity, where an identity may represent a person. That is, the first audio stream may be a recording of the first identity speaking the text of the first text string. The device may generate a second audio stream based on an output of the machine learning model, where the second audio stream may be associated with a second identity (e.g., a second person different from the first identity). In addition, the second audio stream may mimic the first audio stream. That is, the second audio stream may be a generated recording of the second identity speaking the text of the first text string. In addition during the audio-driven talking-head generation procedure of the two-stage framework described herein, the device may generate a video that displays the second identity speaking the first text string based on combining the second audio stream with a visual medium associated with the second identity. The visual medium may include a prior video or a photo of the second identity.

The techniques described herein for zero-shot identity-agnostic talking-head generation may result in one of the following potential improvements. In some examples, the techniques described herein may improve existing zero-shot TTV techniques by combining TTS and audio-driven talking head generation procedures into a two-stage framework. For example, utilizing audio generated from the TTS procedure as an input in the audio-driven talking head generation procedure may increase efficiency by allowing the talking head generation to be identity-agnostic. In addition, by inputting the audio generated from the TTS procedure in addition to some visual media associated with the second identity into the talking head generation model, a user may refrain from retraining the machine learning model for each new identity, thus saving resources and improving efficiency.

Aspects of the disclosure are initially described in the context of an environment supporting an on-demand database service. Aspects of the disclosure are then described in the context of TTV models, TTS models, talking head generation models, and spectrogram models. Aspects of the disclosure are further illustrated by and described with reference to apparatus diagrams, system diagrams, and flowcharts that relate to a two-stage framework for zero-shot identity-agnostic talking-head generation.

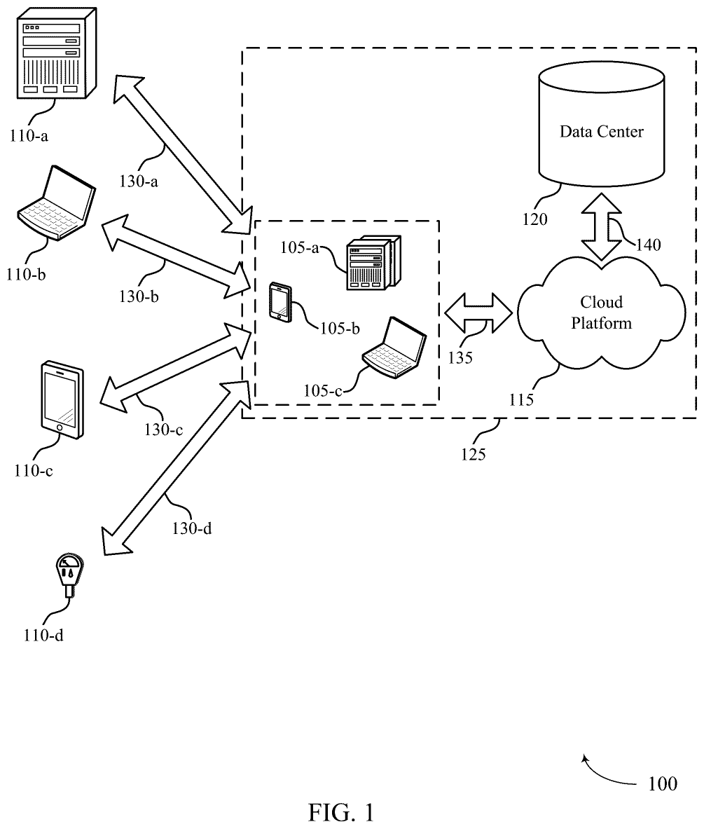

FIG. 1 illustrates an example of a system 100 for cloud computing that supports a two-stage framework for zero-shot identity-agnostic talking-head generation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

A device (e.g., any component of subsystem 125, such as a cloud client 105, a server or server cluster associated with the cloud platform 115 or data center 120, etc.) may support AI chatbots for information gathering and analysis. Such chatbots may be trained on large sets of data. Based on receiving an input from a user (e.g., a question, a prompt, a request, etc.), a chatbot may generate a corresponding output that is effectively a likely prediction corresponding to the input. In some aspects, the chatbot may support TTV techniques which may involve generating videos based on a given text string, enabling enhanced visualization of the information output by the chatbot. For example, the chatbot may receive an input from the user indicating some text string and a person (also referred to herein as an identity) the user wishes to speak the text. If the chatbot is trained on a set of data including audio and video clips of the identity, the chatbot may output a video of the identity speaking the input text string. By leveraging such TTV techniques, the visualization of information (e.g., the text string) may be more accessible and facilitate a more comprehensive understanding of the content.

Specifically, some conventional TTV models may limit the generated video output to a specific identity based on the chatbot being trained on data corresponding to the specific identity. As such, the conventional TTV models are limited regarding generating videos specific to different entities, which may require extensive training processes. In addition, conventional TTV models may rely heavily on an identifier associated with the inputs to the AI chatbot, such that the TTV models may be unable to output a video of a particular identity unless the TTV model is trained on data corresponding to that particular identity.

Some TTV models may include an encoder, a decoder, and a vocoder all used to generate a video from text. For example, an encoder may extract relevant information from a text string and pass the information to a decoder, which may generate a Mel spectrogram. Subsequently, the vocoder may transform the Mel spectrogram into an audio stream. However, such models may have limitations in that the decoder may support an autoregressive model, which may result in slow interference speeds. To overcome such limitations, some decoders may support non-autoregressive models to accelerate the interference speed for TTS synthesis, which may rely on pre-trained neural networks for either the encoder or the vocoder. In such cases, an end-to-end neural network may be used to facilitate simultaneous training of the encoder, decoder, and vocoder. In some examples, these models may be unable to achieve zero-shot capabilities if they are unable to specify and identity of the generated audio. As such, pre-trained speaker encoders may be used for speaker verification and vocoders. In addition, some end-to-end neural networks may be trained to achieve zero-shot, identity-agnostic TTS, and in some other examples, TTS may be facilitated based on generating a neural codec rather than a Mel spectrogram for intermediate representation of the text.

In addition, conventional audio-driven talking head generation models may be separate from a TTS model and may be one of two distinct categories. A first category may include the utilization of head images for audio-driven talking head generation. For instance, some audio-driven talking head generation models may extract information from both the image and audio inputs to predict head motion. Such generated motion prediction may be subsequently employed for flow field prediction, serving as a foundation for video generation. Another approach may include training talking head generation models on specific identities, incorporating a motion field transfer module to bridge the gap between the training identity and the inference identity. Some head images may be represented using sequential three-dimension morphable model (3DMM) coefficients generated based on the audio input. These sequential 3DMM coefficients may be applied for face rendering and video synthesis.

The second category of audio-driven talking head generation may include video-based approaches. For example, some models may utilize image frames from videos for training and modeled an identity's upper body using two separate neural radiance fields defined by implicit functions. Alternatively, some models may focus on achieving lip synchronization for modifying talking head videos, or some other models may accelerate the video generation process by decomposing the dynamic neural radiance field into three components: head, torso, and audio generation. Alternatively, a model may decompose videos into shape, expression, and pose, replacing the expression in videos with the expression extracted from the audio input for video generation.

To reduce training time to generate TTV spoken by a particular identity, some models may decompose the TTV procedure into two stages: a speaker-independent stage and a speaker-specific stage. Alternatively, some TTV models may directly generate audio from video. For example, audio may be initially generated and aligned with corresponding text. Using the generated text and audio, a pose dictionary may be created to predict key point poses. However, such techniques may fail to specify the identity of the speaker in either the audio or the video.

To address these limitations, the data processing system 100 may support a two-stage procedure for zero-shot identity-diagnostic talking-head generation. For example, during a TTS procedure of the two-stage framework described herein, a first audio stream (e.g., recorded speech) and a first text string (e.g., written text) corresponding to the first audio stream may be input into a machine learning model. The first audio stream and the first text string may correspond to a first identity, where an identity may represent a person. That is, the first audio stream may be a recording of the first identity speaking the text of the first text string. The device may generate a second audio stream based on an output of the machine learning model, where the second audio stream may be associated with a second identity (e.g., a second person different from the first identity). In addition, the second audio stream may mimic the first audio stream. That is, the second audio stream may be a generated recording of the second identity speaking the text of the first text string. In addition during an audio-driven talking-head generation procedure of the two-stage framework described herein, the device may generate a video that displays the second identity speaking the first text string based on combining the second audio stream with a visual medium associated with the second identity. The visual medium may include a prior video or a photo of the second identity.

In an example, an audio clip (e.g., a first audio stream) of a first person giving a speech may be input into a machine learning model along with a written transcript of the speech (e.g., a first text string). The machine learning model may be trained on text strings and audio streams corresponding to many different identities. The machine learning model may output a second audio clip (e.g., a second audio stream) of a second person speaking the speech or other text that was input into the machine learning model. That is, the second audio clip may be machine-generated rather than an actual recording of the second person speaking. This second audio clip may then be used to generate a video of the second person speaking the previously-generated audio. To do this, a talking-head generation model may use a previous video or image of the second person along with the second audio clip. That is, instead of generating the audio and video of the second person in parallel processes, the talking-head generation model may use the audio to generate the video. The output video may appear as if it is a recording of the second person speaking the initial text.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

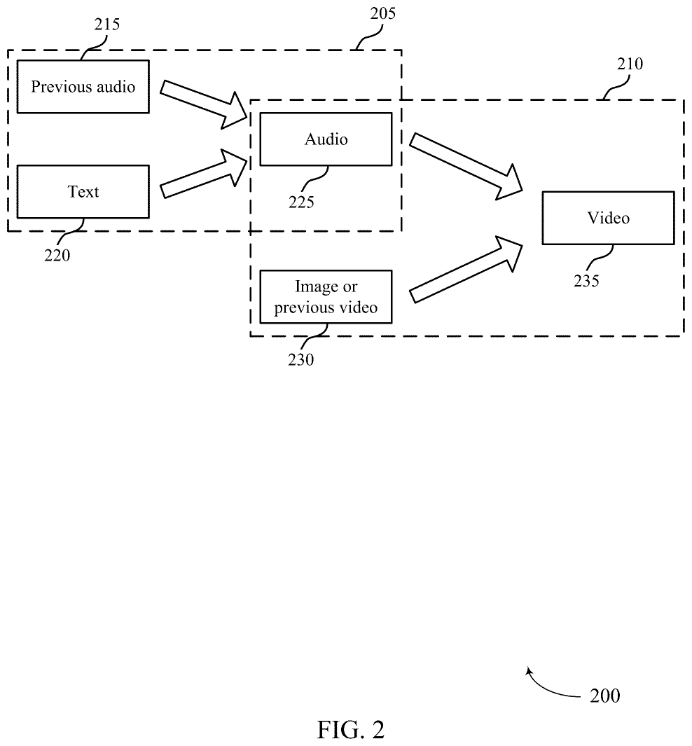

FIG. 2 shows an example of a TTV model 200 that supports a two-stage framework for zero-shot identity-agnostic talking-head generation in accordance with aspects of the present disclosure. The TTV model 200 may be supported by an application server or another system which may be an example of a corresponding device described herein with reference to FIG. 1. In some cases, the functions performed by the application server may instead be performed by another component of the cloud platform 115. In some examples, the application server may support communication with an external server. The TTV model 200 may support a two-stage framework for zero-shot, identity-agnostic talking head generation.

In some examples, the TTV model 200 may include a combination of a TTS model 205 and an audio-driven talking head generation model 210. That is, the TTS model 205 may be a first stage of the two-stage framework and the audio-driven talking head generation model 210 may be a second stage of the two-stage framework. The TTS model 205 may output the audio 225 using previous audio 215 and text 220 as inputs. The audio-driven talking head generation model 210 may generate a video 235 using the audio 225 and an image or previous video 230 as inputs.

A machine learning model may be trained on a set of audio streams, a set of text strings, and a set of visual media (e.g., video clips and images) of a set of multiple different people or identities such that the machine learning model may be generalized to any person for which the video 235 is to be generated. As described herein, the previous audio 215 (e.g., a first audio stream) and the text 220 (e.g., a first text string) may correspond to a first identity or person. For example, the previous audio 215 may be a relatively short recording of the first identity speaking the text 220 (e.g., a sentence, phrase, etc.). The machine learning model may generate the audio 225 (e.g., a second audio stream) based on the previous audio 215 and the text 220, where the audio 225 may be associated with a second identity (e.g., different from the first identity). In addition, the audio 225 may mimic the previous audio 215. For example, the audio 225 may portray the second identity speaking the text 220. By mimicking the style of the provided audio, a new audio may be generated with the specified identity speaking the given text. In this way, generating the audio 225 may be a zero-shot process as it may not require that the machine learning model is first trained on a large dataset specifically corresponding to the second identity.

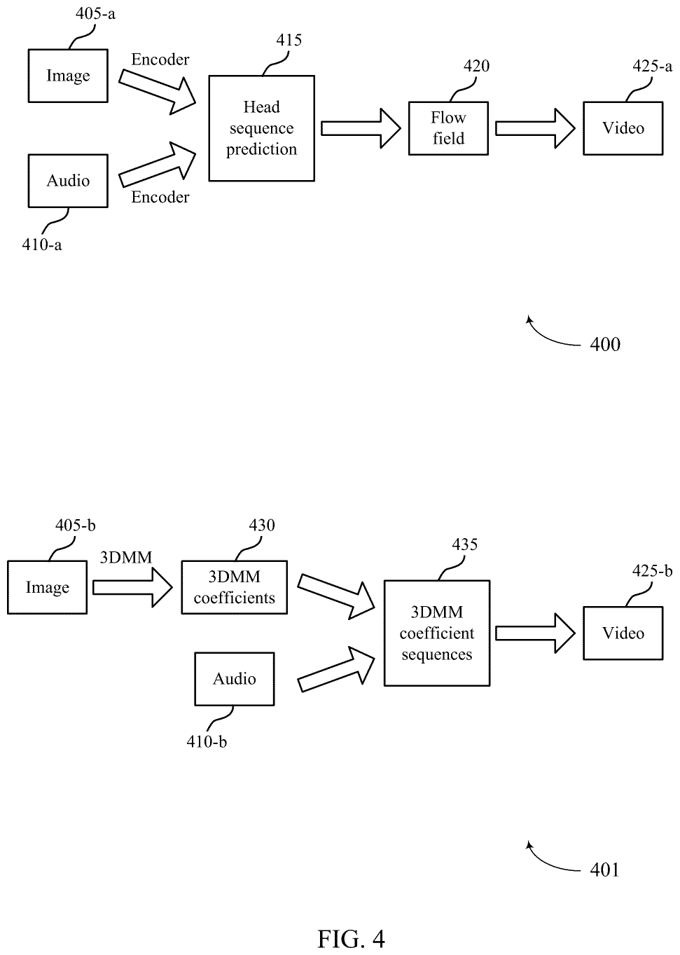

In the second stage, the generated audio may be combined with a pre-existing image or video, integrating it into a well-developed audio-driven talking head generation system. Consequently, videos may be generated that feature the specified identity speaking the provided text, without using additional training processes. For example, the audio-driven talking head generation model 210 may use the audio 225 generated from the TTS model 205 along with the image or previous video 230 to generate the video 235. The image or previous video 230, or some other visual media, may depict the second identity, and may be used to generate a “talking-head” visual as described herein with reference to FIG. 4. For example, the image or previous video 230 may include a video of the second identity speaking different text from the text 220. In this way, the TTV model 200 may be generalized to any person as long as the audio 225 (e.g., a short audio clip) and the image or previous video 230 (e.g., some visual medium) are provided specific to the identity for which the video 235 is to be generated.

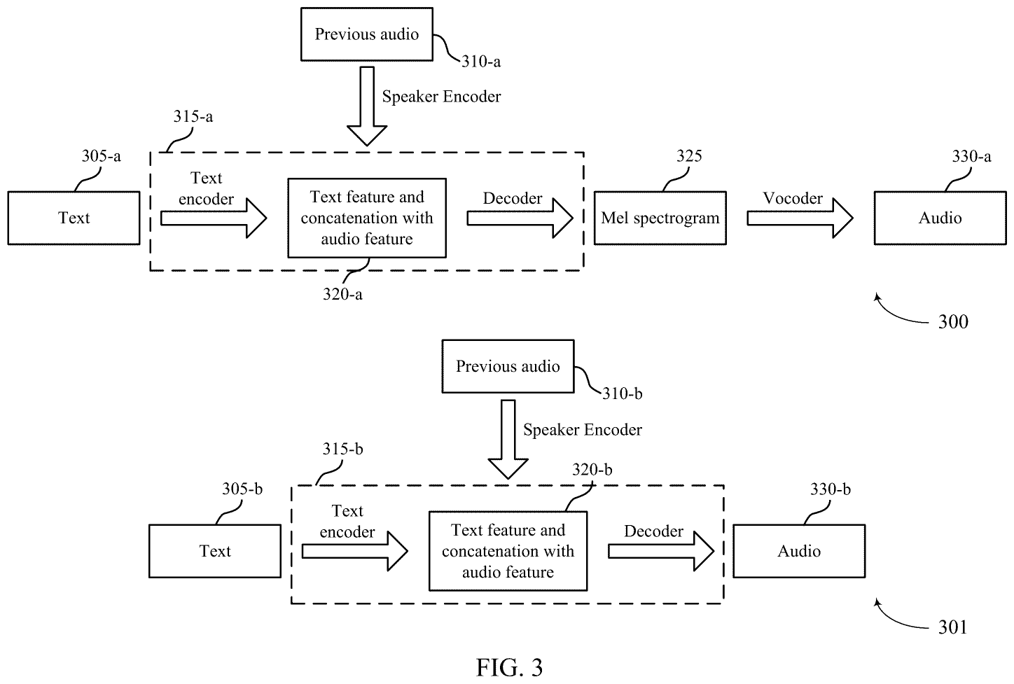

FIG. 3 shows an example of TTS models 300 and 301 that support a two-stage framework for zero-shot identity-agnostic talking-head generation in accordance with aspects of the present disclosure. The TTS models 300 and 301 may be implemented by aspects of the data processing system 100 or the TTV model 200. For example, the TTS models 300 and 301 may be examples of the TTS model 205 as described herein with reference to FIG. 2. A TTS model 300 may be an example of a spectrogram model and a TTS model 301 may be an example of an end-to-end model. The TTS models 300 may support a two-stage framework for zero-shot, identity-agnostic talking head generation.

As described herein with reference to FIG. 2, the TTS models 300 and 301 may generate respective audio 330 that corresponds to a second identity based on previous audio 310 and text 305 that correspond to a first identity. The TTS models 300 and 301 may each include an encoder, a decoder, a vocoder, or some combination thereof. For example, an encoder module may include a speaker encoder (e.g., speech encoder) responsible for extracting information from previous audio 310, and a text encoder responsible for extracting information (e.g., features) from text 305.

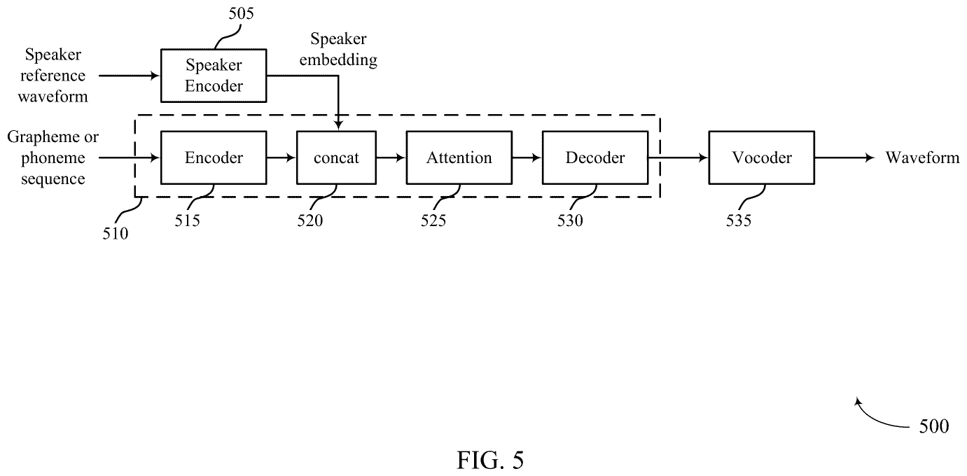

For example, in a TTS model 300, text 305-a and previous audio 310-a may be input into a machine learning model 315-a. The text 305-a may be input into the machine learning model 315-a via a text encoder and the previous audio 310-a may be input via a speaker encoder. The machine learning model 315-a may be trained on sets of audio streams, text strings, and visual media from a set of multiple different identities (including or excluding the first and/or second identities). In some examples, the machine learning model 315-a may utilize text feature and concatenation 320-a with an audio feature to synthesize the text 305-a and the previous audio 310-a together. A decoder module may use concatenated features from the speaker encoder and the text encoder to generate a Mel spectrogram 325 corresponding to the text 305-a. The vocoder may transform the Mel spectrogram 325 into the audio 330-a, which may convey the second identity speaking the text 305-a. A spectrogram model such as the TTS model 300 is described herein with reference to FIG. 5.

The TTS model 301 may represent an end-to-end model, which may train the speaker encoder, text encoder, decoder, and vocoder simultaneously. Such end-to-end models may be capable of using previous audio 310-b and text 305-b as inputs to generate new audio that speaks the prescribed text in the same identity's voice. For example, the text 305-b and previous audio 310-b may be input into a machine learning model 315-b, where the text 305-b may be input into the machine learning model 315-b via a text encoder and the previous audio 310-b may be input via a speaker encoder. The machine learning model 315-b may be trained on sets of audio streams, text strings, and visual media from a set of multiple different identities (including or excluding the first and/or second identities). In some examples, the machine learning model 315-b may utilize text feature and concatenation 320-b with an audio feature to synthesize the text 305-b and the previous audio 310-b together. A decoder may use the text 305-b and the previous audio 310-b to output the audio 330-b, which may convey the second identity speaking the text 305-b.

FIG. 4 shows examples of talking head generation models 400 and 401 that supports a two-stage framework for zero-shot identity-agnostic talking-head generation in accordance with aspects of the present disclosure. The talking head generation models 400 and 401 may be implemented by aspects of the data processing system 100 or the TTV model 200. For example, the talking head generation models 400 may be examples of the audio-driven talking head generation models model 210 as described herein with reference to FIG. 2. A talking head generation model 400 may be an example of an image-based flow field model (e.g., a two-dimensional (2D) model) and a talking head generation model 210 may be an example of an image-based 3DMM (e.g., a 3D model). The talking head generation models 400 and 401 may support a two-stage framework for zero-shot, identity-agnostic talking head generation, which may be utilized to integrate input audio content and generated visual content to produce convincing and synchronized talking head videos.

As described herein with reference to FIG. 2, a TTS model (e.g., the TTS model 205 described herein with reference to FIG. 2) may use an audio stream and a text string corresponding to a first identity as inputs to generate audio 410, which may correspond to a second identity. Then, a talking head generation model 400 may use the audio 410 and some visual medium corresponding to the second identity (e.g., an image 405 or a previous video) to generate a corresponding video 425 of the second identity speaking the original text.

A talking head generation model 400 (e.g., a 2D model) may use an image 405-a, audio 410-a (e.g., previously-generated audio), and a flow field 420 to generate a video 425-a. The image 405-a and the audio 410-a may be input to a head sequence prediction module 415 via respective encoders. The encoders may extract features from the image 405-a and the audio 410-a. For example, a first encoder may identify a first set of features associated with the audio 410-a (e.g., a first audio stream) and a second encoder may identify a second set of features associated with the image 405-a or text (e.g., a first text string). The head sequence prediction module 415 may use the extracted features to generate a head motion sequence. The head motion sequence may correspond to the second identity speaking the text input to the original TTS model based on the first and second sets of features. A flow field 420 may be predicted based on the generated head sequence and applied to a subsequent process to generate the video 425-a. For example, the flow field 420 may be used to synthesize realistic and synchronized movements of the talking head for the video 425-a. In this way, the talking head generation model 400 may leverage different features of the image 405-a and the audio 410-a to generate dynamic visual content in the form of the video 425-a.

Alternatively, the talking head generation model 401 may convert an image 405-b corresponding to the second identity to a 3D model using 3DMM coefficients 430 and a 3DMM coefficient sequences module 435. Using a 3DMM approach may leverage the underlying 3D structure of a head and its variations to synthesize visual representations. The image 405-b (e.g., a 2D image) may be input into a 3DMM coefficient module which may convert the image 405-b into a 3D model. The 3DMM coefficient module may generate a set of 3DMM coefficients 430 that describe the head of the second identity (shown in the image 405-b) in 3D space using some parameters. The 3DMM coefficients 430 may include a set of characteristics associated with the visual medium, where the set of characteristics include one or more geometric parameters and one or more appearance characteristics associated with a head motion of the second identity. That is, the 3DMM coefficients may represent geometric and appearance-based characteristics of the head. In addition, a 3DMM coefficient sequences module 435 may combine the 3DMM coefficients 430 and audio 410-b (e.g., audio previously-generated by the TTS model) to generate a video 425-b corresponding to the second identity. The 3DMM coefficient module may gather coefficients from the image 405-b at different times (e.g., using different images of the second identity) or from audio inputs corresponding to the second identity.

FIG. 5 shows an example of a spectrogram model 500 that supports a two-stage framework for zero-shot identity-agnostic talking-head generation in accordance with aspects of the present disclosure. The spectrogram model 500 may be implemented by aspects of the data processing system 100, the TTV model 200, or the TTS models 300. For example, the spectrogram model 500 may be an example of the TTS model 300 as described herein with reference to FIG. 3. The spectrogram model 500 may support a two-stage framework for zero-shot, identity-agnostic talking head generation, which may be utilized to integrate input audio content and generated visual content to produce convincing and synchronized talking head videos.

The spectrogram model 500 may be a type of TTS model which may be trained to build a connection between each text string that is input and audio that is output. The spectrogram model 500 may include a speaker encoder 505, a synthesizer 510, and a vocoder 535, each of which may be trained separately A speaker reference waveform may be input in a speaker encoder 505. The speaker reference waveform may represent an audio stream (e.g., three to five seconds of previous audio) of a second identity for which a video is to be generated. As such, the speaker encoder 505 may be associated with a specific identity, while the other components of the spectrogram model 500 may be generalized and trained for any identity. In addition, a grapheme or phoneme sequence may be input to a synthesizer 510, where the phoneme sequence for example may represent a text string that the second identity is to speak. The text may be transformed to the phoneme form for easier use in the synthesizer 510.

An encoder 515 of the synthesizer 510 may convert the speaker reference waveform into a speaker embedding that is input to a concatenation 520 with the encoded phoneme sequence. The concatenated phoneme sequence and speaker embedding may be input through an attention module 525 and the decoder 530 to transform the phoneme sequence into a waveform. In some aspects, the synthesizer may train a neural network using some features extracted from the speaker reference waveform and the phoneme sequence, the neural network used to generate the final waveform as an audio stream corresponding to the second identity. The decoder 530 may output the waveform to the vocoder 535, at which point a Mel spectrogram may be applied to the waveform to ultimately output the waveform as the audio stream.

In some aspects, each word of the speaker reference waveform may be spoken with a different cadence and time. For example, a two-syllable word may span more time than a one-syllable word. As such, the neural network and the Mel spectrogram may be trained to predict how each word of the phoneme sequence is to be pronounced and how long each word may be spoken.

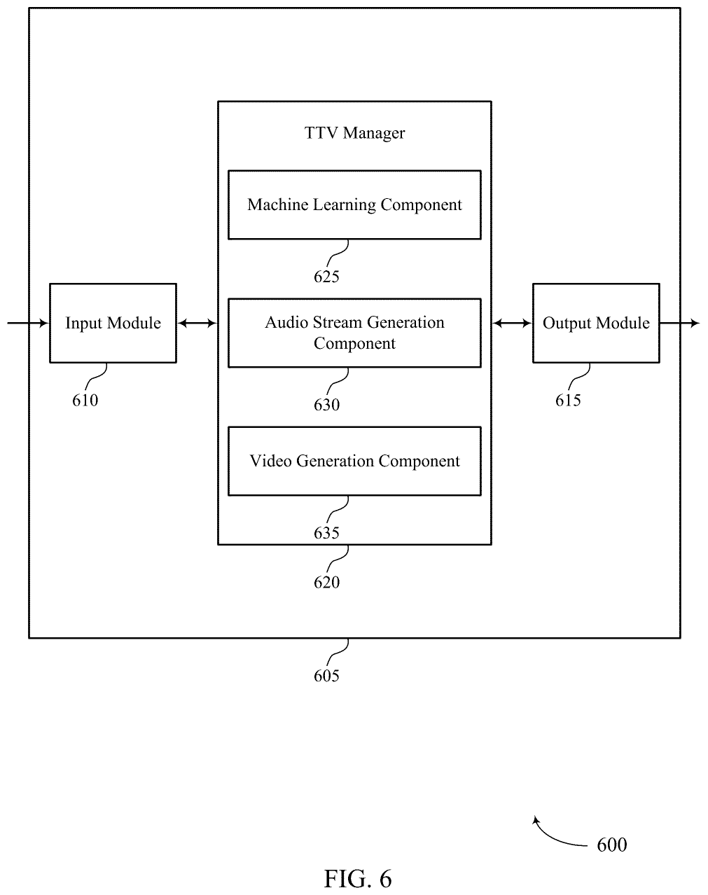

FIG. 6 shows a block diagram 600 of a device 605 that supports a two-stage framework for zero-shot identity-agnostic talking-head generation in accordance with aspects of the present disclosure. The device 605 may include an input module 610, an output module 615, and a TTV manager 620. The device 605, or one or more components of the device 605 (e.g., the input module 610, the output module 615, and the TTV manager 620), may include at least one processor, which may be coupled with at least one memory, to support the described techniques. Each of these components may be in communication with one another (e.g., via one or more buses).

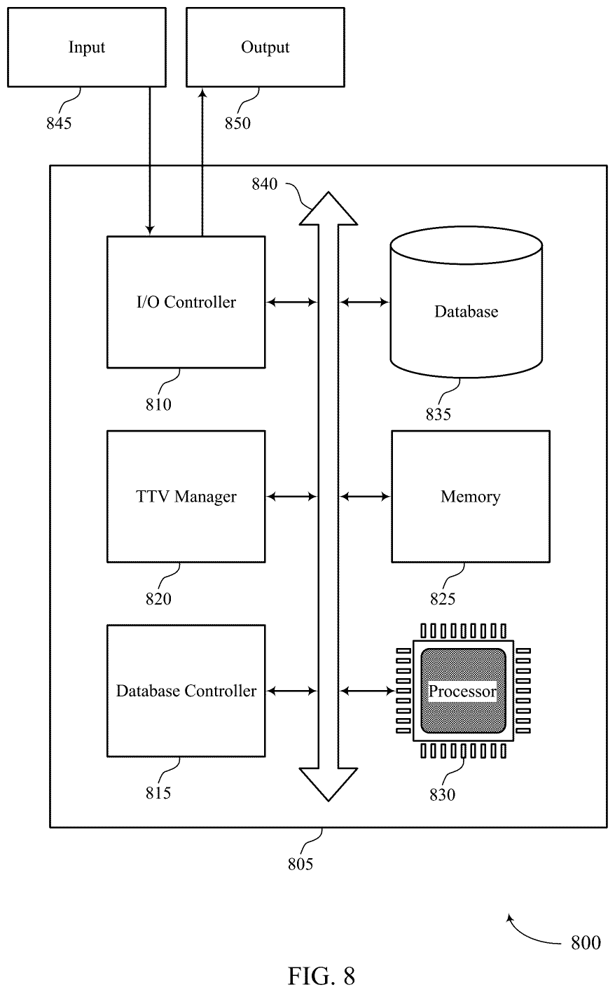

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the TTV manager 620 to support a two-stage framework for zero-shot identity-agnostic talking-head generation. In some cases, the input module 610 may be a component of an input/output (I/O) controller 810 as described with reference to FIG. 8.

The output module 615 may manage output signals for the device 605. For example, the output module 615 may receive signals from other components of the device 605, such as the TTV manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the TTV manager 620 may include a machine learning component 625, an audio stream generation component 630, a video generation component 635, or any combination thereof. In some examples, the TTV manager 620, or various components thereof, may be configured to perform various operations (e.g., receiving, monitoring, transmitting) using or otherwise in cooperation with the input module 610, the output module 615, or both. For example, the TTV manager 620 may receive information from the input module 610, send information to the output module 615, or be integrated in combination with the input module 610, the output module 615, or both to receive information, transmit information, or perform various other operations as described herein.

The TTV manager 620 may support data generation in accordance with examples as disclosed herein. The machine learning component 625 may be configured to support inputting a first audio stream and a first text string corresponding to the first audio stream into a machine learning model, where the first audio stream and the first text string correspond to a first identity. The audio stream generation component 630 may be configured to support generating a second audio stream based on an output of the machine learning model, where the second audio stream is associated with a second identity and mimics the first audio stream. The video generation component 635 may be configured to support generating a video that displays the second identity speaking the first text string based on combining the second audio stream with a visual medium associated with the second identity.

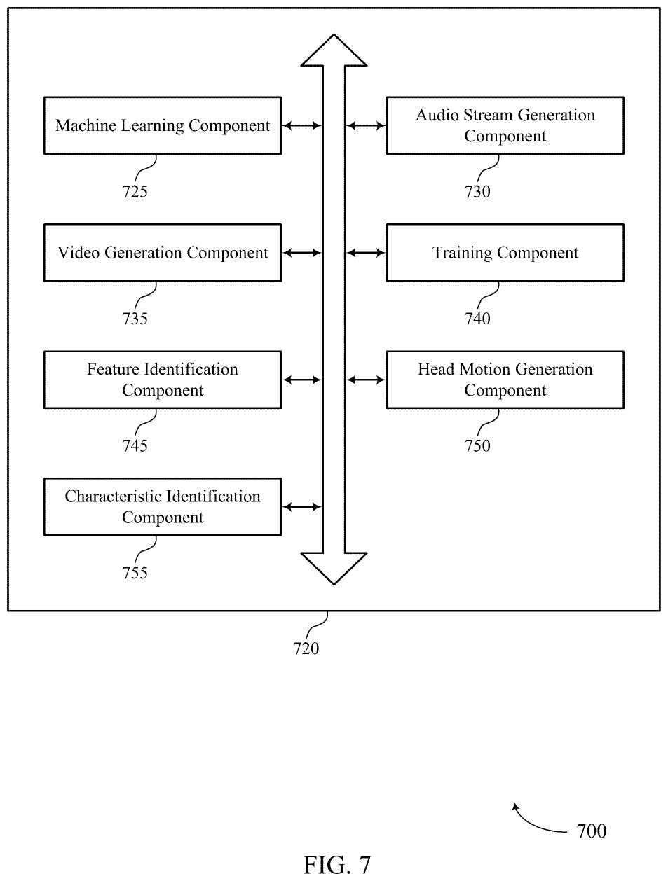

FIG. 7 shows a block diagram 700 of a TTV manager 720 that supports a two-stage framework for zero-shot identity-agnostic talking-head generation in accordance with aspects of the present disclosure. The TTV manager 720 may be an example of aspects of a TTV manager or a TTV manager 620, or both, as described herein. The TTV manager 720, or various components thereof, may be an example of means for performing various aspects of a two-stage framework for zero-shot identity-agnostic talking-head generation as described herein. For example, the TTV manager 720 may include a machine learning component 725, an audio stream generation component 730, a video generation component 735, a training component 740, a feature identification component 745, a head motion generation component 750, a characteristic identification component 755, or any combination thereof. Each of these components, or components of subcomponents thereof (e.g., one or more processors, one or more memories), may communicate, directly or indirectly, with one another (e.g., via one or more buses).

The TTV manager 720 may support data generation in accordance with examples as disclosed herein. The machine learning component 725 may be configured to support inputting a first audio stream and a first text string corresponding to the first audio stream into a machine learning model, where the first audio stream and the first text string correspond to a first identity. The audio stream generation component 730 may be configured to support generating a second audio stream based on an output of the machine learning model, where the second audio stream is associated with a second identity and mimics the first audio stream. The video generation component 735 may be configured to support generating a video that displays the second identity speaking the first text string based on combining the second audio stream with a visual medium associated with the second identity.

In some examples, the training component 740 may be configured to support training the machine learning model based on a set of audio streams and a set of text strings, where the set of audio streams and the set of text strings correspond to a set of multiple identifiers.

In some examples, the feature identification component 745 may be configured to support identifying a first set of features associated with the first audio stream. In some examples, the feature identification component 745 may be configured to support identifying a second set of features associated with the first text string. In some examples, the head motion generation component 750 may be configured to support generating a head motion sequence corresponding to the second identity speaking the first text string based on the first set of features and the second set of features.

In some examples, to support generating the video, the video generation component 735 may be configured to support generating the video based on the generated head motion sequence.

In some examples, the characteristic identification component 755 may be configured to support identifying a set of characteristics associated with the visual medium, where the set of characteristics include one or more geometric parameters and one or more appearance characteristics associated with a head motion of the second identity.

In some examples, to support generating the video, the head motion generation component 750 may be configured to support generating the video based on combining the set of characteristics with the first audio stream.

FIG. 8 shows a diagram of a system 800 including a device 805 that supports a two-stage framework for zero-shot identity-agnostic talking-head generation in accordance with aspects of the present disclosure. The device 805 may be an example of or include the components of a device 605 as described herein. The device 805 may include components for bi-directional data communications including components for transmitting and receiving communications, such as a TTV manager 820, an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting a two-stage framework for zero-shot identity-agnostic talking-head generation). The processor 830 may be an example of a single processor or multiple processors. For example, the device 805 may include one or more processors 830.

The TTV manager 820 may support data generation in accordance with examples as disclosed herein. For example, the TTV manager 820 may be configured to support inputting a first audio stream and a first text string corresponding to the first audio stream into a machine learning model, where the first audio stream and the first text string correspond to a first identity. The TTV manager 820 may be configured to support generating a second audio stream based on an output of the machine learning model, where the second audio stream is associated with a second identity and mimics the first audio stream. The TTV manager 820 may be configured to support generating a video that displays the second identity speaking the first text string based on combining the second audio stream with a visual medium associated with the second identity.

By including or configuring the TTV manager 820 in accordance with examples as described herein, the device 805 may support techniques for a two-stage framework for zero-shot identity-agnostic talking-head generation, which may reduce latency, improve efficiency of TTV and TTS operations, reduce resource consumption, and improve the overall result of talking-head generation.

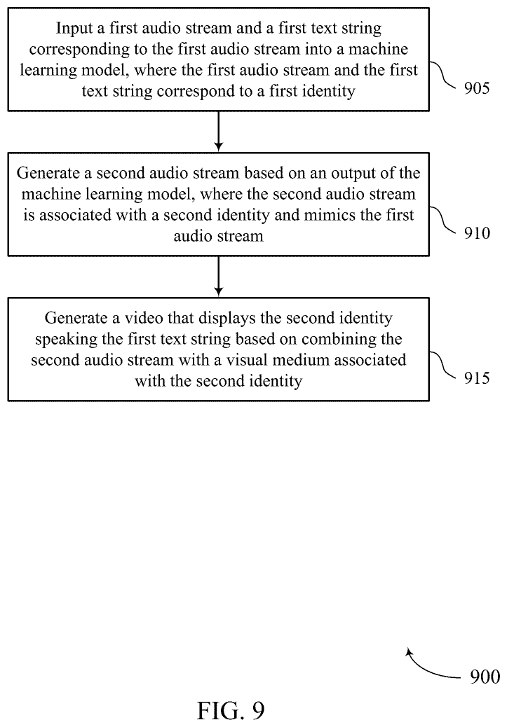

FIG. 9 shows a flowchart illustrating a method 900 that supports a two-stage framework for zero-shot identity-agnostic talking-head generation in accordance with aspects of the present disclosure. The operations of the method 900 may be implemented by a TTV manager or its components as described herein. For example, the operations of the method 900 may be performed by a TTV manager as described with reference to FIGS. 1 through 8. In some examples, a TTV manager may execute a set of instructions to control the functional elements of the TTV manager to perform the described functions. Additionally, or alternatively, the TTV manager may perform aspects of the described functions using special-purpose hardware.

At 905, the method may include inputting a first audio stream and a first text string corresponding to the first audio stream into a machine learning model, where the first audio stream and the first text string correspond to a first identity. The operations of 905 may be performed in accordance with examples as disclosed herein. In some examples, aspects of the operations of 905 may be performed by a machine learning component 725 as described with reference to FIG. 7.

At 910, the method may include generating a second audio stream based on an output of the machine learning model, where the second audio stream is associated with a second identity and mimics the first audio stream. The operations of 910 may be performed in accordance with examples as disclosed herein. In some examples, aspects of the operations of 910 may be performed by an audio stream generation component 730 as described with reference to FIG. 7.

At 915, the method may include generating a video that displays the second identity speaking the first text string based on combining the second audio stream with a visual medium associated with the second identity. The operations of 915 may be performed in accordance with examples as disclosed herein. In some examples, aspects of the operations of 915 may be performed by a video generation component 735 as described with reference to FIG. 7.

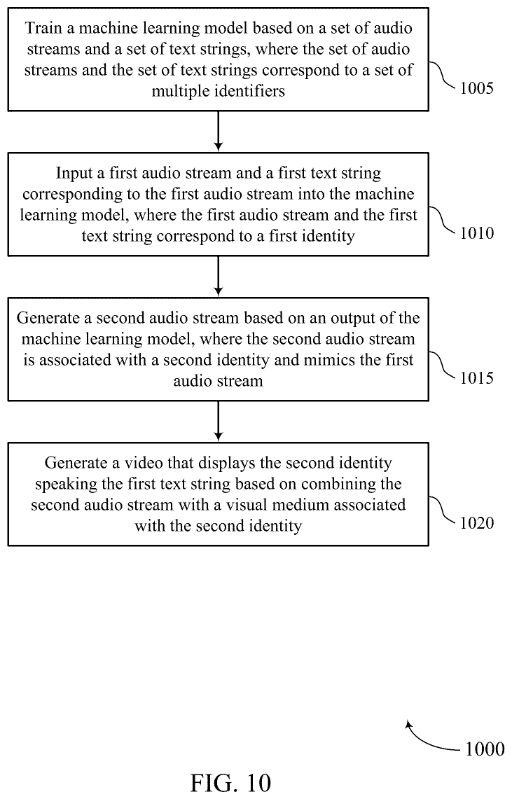

FIG. 10 shows a flowchart illustrating a method 1000 that supports a two-stage framework for zero-shot identity-agnostic talking-head generation in accordance with aspects of the present disclosure. The operations of the method 1000 may be implemented by a TTV manager or its components as described herein. For example, the operations of the method 1000 may be performed by a TTV manager as described with reference to FIGS. 1 through 8. In some examples, a TTV manager may execute a set of instructions to control the functional elements of the TTV manager to perform the described functions. Additionally, or alternatively, the TTV manager may perform aspects of the described functions using special-purpose hardware.

At 1005, the method may include training a machine learning model based on a set of audio streams and a set of text strings, where the set of audio streams and the set of text strings correspond to a set of multiple identifiers. The operations of 1005 may be performed in accordance with examples as disclosed herein. In some examples, aspects of the operations of 1005 may be performed by a training component 740 as described with reference to FIG. 7.

At 1010, the method may include inputting a first audio stream and a first text string corresponding to the first audio stream into the machine learning model, where the first audio stream and the first text string correspond to a first identity. The operations of 1010 may be performed in accordance with examples as disclosed herein. In some examples, aspects of the operations of 1010 may be performed by a machine learning component 725 as described with reference to FIG. 7.

At 1015, the method may include generating a second audio stream based on an output of the machine learning model, where the second audio stream is associated with a second identity and mimics the first audio stream. The operations of 1015 may be performed in accordance with examples as disclosed herein. In some examples, aspects of the operations of 1015 may be performed by an audio stream generation component 730 as described with reference to FIG. 7.

At 1020, the method may include generating a video that displays the second identity speaking the first text string based on combining the second audio stream with a visual medium associated with the second identity. The operations of 1020 may be performed in accordance with examples as disclosed herein. In some examples, aspects of the operations of 1020 may be performed by a video generation component 735 described with reference to FIG. 7.

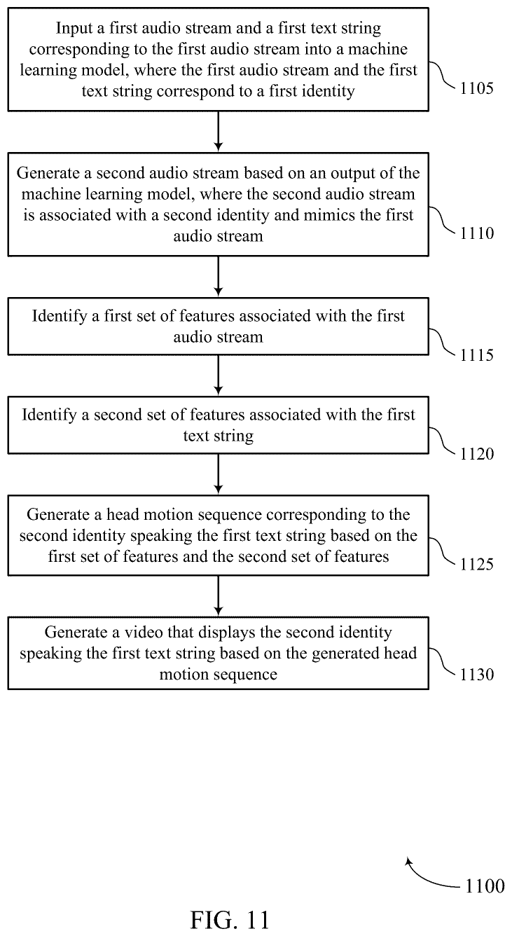

FIG. 11 shows a flowchart illustrating a method 1100 that supports a two-stage framework for zero-shot identity-agnostic talking-head generation in accordance with aspects of the present disclosure. The operations of the method 1100 may be implemented by a TTV manager or its components as described herein. For example, the operations of the method 1100 may be performed by a TTV manager as described with reference to FIGS. 1 through 8. In some examples, a TTV manager may execute a set of instructions to control the functional elements of the TTV manager to perform the described functions. Additionally, or alternatively, the TTV manager may perform aspects of the described functions using special-purpose hardware.

At 1105, the method may include inputting a first audio stream and a first text string corresponding to the first audio stream into a machine learning model, where the first audio stream and the first text string correspond to a first identity. The operations of 1105 may be performed in accordance with examples as disclosed herein. In some examples, aspects of the operations of 1105 may be performed by a machine learning component 725 as described with reference to FIG. 7.

At 1110, the method may include generating a second audio stream based on an output of the machine learning model, where the second audio stream is associated with a second identity and mimics the first audio stream. The operations of 1110 may be performed in accordance with examples as disclosed herein. In some examples, aspects of the operations of 1110 may be performed by an audio stream generation component 730 as described with reference to FIG. 7.

At 1115, the method may include identifying a first set of features associated with the first audio stream. The operations of 1115 may be performed in accordance with examples as disclosed herein. In some examples, aspects of the operations of 1115 may be performed by a feature identification component 745 as described with reference to FIG. 7.

At 1120, the method may include identifying a second set of features associated with the first text string. The operations of 1120 may be performed in accordance with examples as disclosed herein. In some examples, aspects of the operations of 1120 may be performed by a feature identification component 745 as described with reference to FIG. 7.

At 1125, the method may include generating a head motion sequence corresponding to the second identity speaking the first text string based on the first set of features and the second set of features. The operations of 1125 may be performed in accordance with examples as disclosed herein. In some examples, aspects of the operations of 1125 may be performed by a head motion generation component 750 as described with reference to FIG. 7.

At 1130, the method may include generating a video that displays the second identity speaking the first text string based on the generated head motion sequence. The operations of 1130 may be performed in accordance with examples as disclosed herein. In some examples, aspects of the operations of 1130 may be performed by a video generation component 735 as described with reference to FIG. 7.

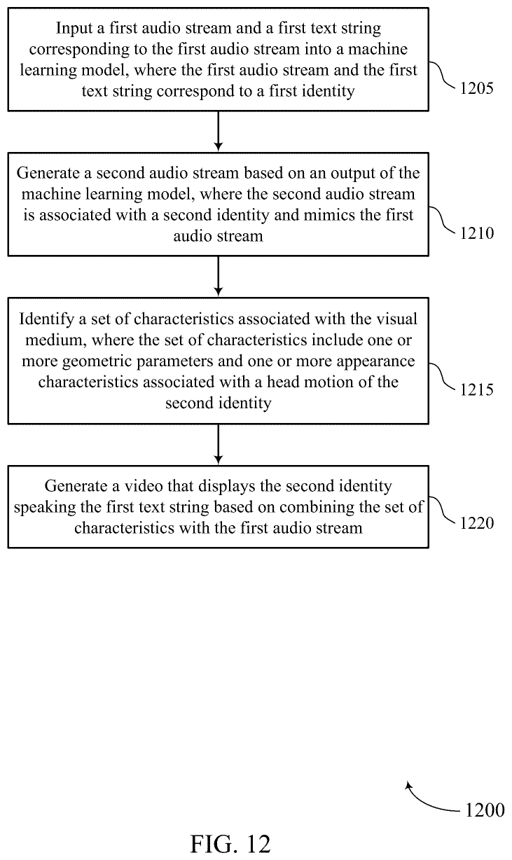

FIG. 12 shows a flowchart illustrating a method 1200 that supports a two-stage framework for zero-shot identity-agnostic talking-head generation in accordance with aspects of the present disclosure. The operations of the method 1200 may be implemented by a TTV manager or its components as described herein. For example, the operations of the method 1200 may be performed by a TTV manager as described with reference to FIGS. 1 through 8. In some examples, a TTV manager may execute a set of instructions to control the functional elements of the TTV manager to perform the described functions. Additionally, or alternatively, the TTV manager may perform aspects of the described functions using special-purpose hardware.

At 1205, the method may include inputting a first audio stream and a first text string corresponding to the first audio stream into a machine learning model, where the first audio stream and the first text string correspond to a first identity. The operations of 1205 may be performed in accordance with examples as disclosed herein. In some examples, aspects of the operations of 1205 may be performed by a machine learning component 725 as described with reference to FIG. 7.

At 1210, the method may include generating a second audio stream based on an output of the machine learning model, where the second audio stream is associated with a second identity and mimics the first audio stream. The operations of 1210 may be performed in accordance with examples as disclosed herein. In some examples, aspects of the operations of 1210 may be performed by an audio stream generation component 730 as described with reference to FIG. 7.

At 1215, the method may include identifying a set of characteristics associated with the visual medium, where the set of characteristics include one or more geometric parameters and one or more appearance characteristics associated with a head motion of the second identity. The operations of 1215 may be performed in accordance with examples as disclosed herein. In some examples, aspects of the operations of 1215 may be performed by a characteristic identification component 755 as described with reference to FIG. 7.

At 1220, the method may include generating a video that displays the second identity speaking the first text string based on combining the set of characteristics with the first audio stream. The operations of 1220 may be performed in accordance with examples as disclosed herein. In some examples, aspects of the operations of 1220 may be performed by a head motion generation component 750 as described with reference to FIG. 7.

A method for data generation by an apparatus is described. The method may include inputting a first audio stream and a first text string corresponding to the first audio stream into a machine learning model, where the first audio stream and the first text string correspond to a first identity, generating a second audio stream based on an output of the machine learning model, where the second audio stream is associated with a second identity and mimics the first audio stream, and generating a video that displays the second identity speaking the first text string based on combining the second audio stream with a visual medium associated with the second identity.

An apparatus for data generation is described. The apparatus may include one or more memories storing processor executable code, and one or more processors coupled with the one or more memories. The one or more processors may individually or collectively operable to execute the code to cause the apparatus to input a first audio stream and a first text string corresponding to the first audio stream into a machine learning model, where the first audio stream and the first text string correspond to a first identity, generate a second audio stream based on an output of the machine learning model, where the second audio stream is associated with a second identity and mimics the first audio stream, and generate a video that displays the second identity speaking the first text string based on combining the second audio stream with a visual medium associated with the second identity.

Another apparatus for data generation is described. The apparatus may include means for inputting a first audio stream and a first text string corresponding to the first audio stream into a machine learning model, where the first audio stream and the first text string correspond to a first identity, means for generating a second audio stream based on an output of the machine learning model, where the second audio stream is associated with a second identity and mimics the first audio stream, and means for generating a video that displays the second identity speaking the first text string based on combining the second audio stream with a visual medium associated with the second identity.

A non-transitory computer-readable medium storing code for data generation is described. The code may include instructions executable by a processor to input a first audio stream and a first text string corresponding to the first audio stream into a machine learning model, where the first audio stream and the first text string correspond to a first identity. generate a second audio stream based on an output of the machine learning model, where the second audio stream is associated with a second identity and mimics the first audio stream, and generate a video that displays the second identity speaking the first text string based on combining the second audio stream with a visual medium associated with the second identity.

Some examples of the method, apparatus, and non-transitory computer-readable medium described herein may further include operations, features, means, or instructions for training the machine learning model based on a set of audio streams and a set of text strings, where the set of audio streams and the set of text strings correspond to a set of multiple identifiers.

Some examples of the method, apparatus, and non-transitory computer-readable medium described herein may further include operations, features, means, or instructions for identifying a first set of features associated with the first audio stream, identifying a second set of features associated with the first text string, and generating a head motion sequence corresponding to the second identity speaking the first text string based on the first set of features and the second set of features.

In some examples of the method, apparatus, and non-transitory computer-readable medium described herein, generating the video may include operations, features, means, or instructions for generating the video based on the generated head motion sequence.

Some examples of the method, apparatus, and non-transitory computer-readable medium described herein may further include operations, features, means, or instructions for identifying a set of characteristics associated with the visual medium, where the set of characteristics include one or more geometric parameters and one or more appearance characteristics associated with a head motion of the second identity.

In some examples of the method, apparatus, and non-transitory computer-readable medium described herein, generating the video may include operations, features, means, or instructions for generating the video based on combining the set of characteristics with the first audio stream.

The following provides an overview of aspects of the present disclosure:

Aspect 1: A method for data generation, comprising: inputting a first audio stream and a first text string corresponding to the first audio stream into a machine learning model, wherein the first audio stream and the first text string correspond to a first identity; generating a second audio stream based at least in part on an output of the machine learning model, wherein the second audio stream is associated with a second identity and mimics the first audio stream; and generating a video that displays the second identity speaking the first text string based at least in part on combining the second audio stream with a visual medium associated with the second identity.

Aspect 2: The method of aspect 1, further comprising: training the machine learning model based at least in part on a set of audio streams and a set of text strings, wherein the set of audio streams and the set of text strings correspond to a plurality of identifiers.

Aspect 3: The method of any of aspects 1 through 2, further comprising: identifying a first set of features associated with the first audio stream; identifying a second set of features associated with the first text string; and generating a head motion sequence corresponding to the second identity speaking the first text string based at least in part on the first set of features and the second set of features.

Aspect 4: The method of aspect 3, wherein generating the video comprises: generating the video based at least in part on the generated head motion sequence.

Aspect 5: The method of any of aspects 1 through 4, further comprising: identifying a set of characteristics associated with the visual medium, wherein the set of characteristics include one or more geometric parameters and one or more appearance characteristics associated with a head motion of the second identity.

Aspect 6: The method of aspect 5, wherein generating the video comprises: generating the video based at least in part on combining the set of characteristics with the first audio stream.

Aspect 7: An apparatus for data generation, comprising one or more memories storing processor-executable code, and one or more processors coupled with the one or more memories and individually or collectively operable to execute the code to cause the apparatus to perform a method of any of aspects 1 through 6.

Aspect 8: An apparatus for data generation, comprising at least one means for performing a method of any of aspects 1 through 6.

Aspect 9: A non-transitory computer-readable medium storing code for data generation, the code comprising instructions executable by a processor to perform a method of any of aspects 1 through 6.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data generation, comprising:
inputting a first audio stream and a first text string corresponding to the first audio stream into a machine learning model, wherein the first audio stream and the first text string correspond to a first identity;
generating a second audio stream based at least in part on an output of the machine learning model, wherein the second audio stream is associated with a second identity and mimics the first audio stream; and
generating a video that displays the second identity speaking the first text string based at least in part on combining the second audio stream with a visual medium associated with the second identity.

2. The method of claim 1, further comprising:
training the machine learning model based at least in part on a set of audio streams and a set of text strings, wherein the set of audio streams and the set of text strings correspond to a plurality of identifiers.

3. The method of claim 1, further comprising:
identifying a first set of features associated with the first audio stream;
identifying a second set of features associated with the first text string; and
generating a head motion sequence corresponding to the second identity speaking the first text string based at least in part on the first set of features and the second set of features.

4. The method of claim 3, wherein generating the video comprises:
generating the video based at least in part on the generated head motion sequence.

5. The method of claim 1, further comprising:
identifying a set of characteristics associated with the visual medium, wherein the set of characteristics include one or more geometric parameters and one or more appearance characteristics associated with a head motion of the second identity.

6. The method of claim 5, wherein generating the video comprises:
generating the video based at least in part on combining the set of characteristics with the first audio stream.

7. An apparatus for data generation, comprising:
one or more memories storing processor-executable code; and
one or more processors coupled with the one or more memories and individually or collectively operable to execute the code to cause the apparatus to:
input a first audio stream and a first text string corresponding to the first audio stream into a machine learning model, wherein the first audio stream and the first text string correspond to a first identity;
generate a second audio stream based at least in part on an output of the machine learning model, wherein the second audio stream is associated with a second identity and mimics the first audio stream; and
generate a video that displays the second identity speaking the first text string based at least in part on combining the second audio stream with a visual medium associated with the second identity.

8. The apparatus of claim 7, wherein the one or more processors are individually or collectively further operable to execute the code to cause the apparatus to:
train the machine learning model based at least in part on a set of audio streams and a set of text strings, wherein the set of audio streams and the set of text strings correspond to a plurality of identifiers.

9. The apparatus of claim 7, wherein the one or more processors are individually or collectively further operable to execute the code to cause the apparatus to:
identify a first set of features associated with the first audio stream;
identify a second set of features associated with the first text string; and
generate a head motion sequence corresponding to the second identity speaking the first text string based at least in part on the first set of features and the second set of features.

10. The apparatus of claim 9, wherein, to generate the video, the one or more processors are individually or collectively operable to execute the code to cause the apparatus to:
generate the video based at least in part on the generated head motion sequence.

11. The apparatus of claim 7, wherein the one or more processors are individually or collectively further operable to execute the code to cause the apparatus to:
identify a set of characteristics associated with the visual medium, wherein the set of characteristics include one or more geometric parameters and one or more appearance characteristics associated with a head motion of the second identity.

12. The apparatus of claim 11, wherein, to generate the video, the one or more processors are individually or collectively operable to execute the code to cause the apparatus to:
generate the video based at least in part on combining the set of characteristics with the first audio stream.

13. A non-transitory computer-readable medium storing code for data generation, the code comprising instructions executable by one or more processors to:
input a first audio stream and a first text string corresponding to the first audio stream into a machine learning model, wherein the first audio stream and the first text string correspond to a first identity;
generate a second audio stream based at least in part on an output of the machine learning model, wherein the second audio stream is associated with a second identity and mimics the first audio stream; and
generate a video that displays the second identity speaking the first text string based at least in part on combining the second audio stream with a visual medium associated with the second identity.

14. The non-transitory computer-readable medium of claim 13, wherein the instructions are further executable by the one or more processors to:
train the machine learning model based at least in part on a set of audio streams and a set of text strings, wherein the set of audio streams and the set of text strings correspond to a plurality of identifiers.

15. The non-transitory computer-readable medium of claim 13, wherein the instructions are further executable by the one or more processors to:
identify a first set of features associated with the first audio stream;
identify a second set of features associated with the first text string; and
generate a head motion sequence corresponding to the second identity speaking the first text string based at least in part on the first set of features and the second set of features.

16. The non-transitory computer-readable medium of claim 15, wherein the instructions to generate the video are executable by the one or more processors to:
generate the video based at least in part on the generated head motion sequence.

17. The non-transitory computer-readable medium of claim 13, wherein the instructions are further executable by the one or more processors to:
identify a set of characteristics associated with the visual medium, wherein the set of characteristics include one or more geometric parameters and one or more appearance characteristics associated with a head motion of the second identity.

18. The non-transitory computer-readable medium of claim 17, wherein the instructions to generate the video are executable by the one or more processors to:
generate the video based at least in part on combining the set of characteristics with the first audio stream.
